(19) United States
(12) Patent Application Publication
(10) Pub. No.: US 2013/0106816 A1
(43) Pub. Date: May 2, 2013

(54) APPARATUS AND ASSOCIATED METHODS FOR REDUCED BIT LINE SWITCHING ACTIVITY IN PIXEL DRIVER MEMORIES

(71) Applicants: Peter Lapidus, Boulder, CO (US); Michael Yee, Broomfield, CO (US); Bruce C. Gamache, Boulder, CO (US)

(72) Inventors: Peter Lapidus, Boulder, CO (US); Michael Yee, Broomfield, CO (US); Bruce C. Gamache, Boulder, CO (US)

(21) Appl. No.: 13/287,742

(22) Filed: Nov. 2, 2011

(51) Int. Cl. G09G 5/00

(52) U.S. Cl. 345/211

(57) ABSTRACT

A controller and method have been described for use in conjunction with a sequential display system including a display having a plurality of pixels. A series of update cycles is performed on the display to establish the grayscale value of each pixel for viewing a given frame using the display during which update cycles each pixel can have a single update to change states and without refreshing an existing state of the pixel.

### BACKGROUND

The present invention is generally related to the field of sequential displays.

There are a number of competing technologies in the field of modern displays. One particularly advantageous type of modern display is the field sequential display using a ferroelectric liquid crystal on silicon (FLCOS) pixel array. The pixel array of the FLCOS display is capable of extremely fast switching such that it is ideally suited to the display of real time video. Some of these displays have been configured for illumination by LEDs. These displays can offer a bright and accurate image across a wide range of operating conditions from a very small package. Projection type FLCOS display arrangements with LED-based light engines have been successfully integrated in portable, battery powered devices such as, for example, cellular telephones.

A field sequential display generally presents video to a viewer by breaking the frames of an incoming video stream into subframes of individual red, green and blue subframes. Only one color subframe is presented to the viewer at a time. That is, the pixels of the pixel array can be illuminated at different times by an appropriate color of light associated with the red, green and blue subframes in a way that produces a grayscale image for each subframe. The color subframes can be presented to the viewer so rapidly, however, that the eye of the viewer integrates the individual color subframes into a full color image. In the instance of an incoming video stream, the processing for purposes of generating the subframes is generally performed in real time while the pixels of the display are likewise driven in real time.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic illustration of an embodiment of a system in block diagram form that is configured for operation according to the present disclosure.

FIG. 2 is a perspective view of embodiments of certain components of the system of FIG. 1, shown here to illustrate features of their operation.

FIG. 3 is a block diagram illustrating an embodiment of a controller, light source and display of the system of FIG. 1, shown here to illustrate further details of their operation.

FIG. 4 is a schematic diagram of an embodiment of a pixel driver that can be used in the configurations of FIGS. 1-3.

FIG. 5 is a diagrammatic illustration of a video stream made up of frames that is used by the controller of FIGS. 1-3 to produce a series of color subframes and further demonstrates a hypothetical set of pixel values, for explanatory purposes, presented on the display of FIGS. 1-3 for a subframe.

FIG. 6 is a graphical representation of an embodiment of an update ramp for purposes of illustrating the operation of the system of FIGS. 1-3.

FIG. 7 is a flow diagram that illustrates an embodiment of a method for the operation of the system of FIGS. 1-3 which can efficiently update pixels in a subframe.

FIG. 8 is a table showing an embodiment of an update cycle for a single pixel in a subframe using the system of FIGS. 1-3.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

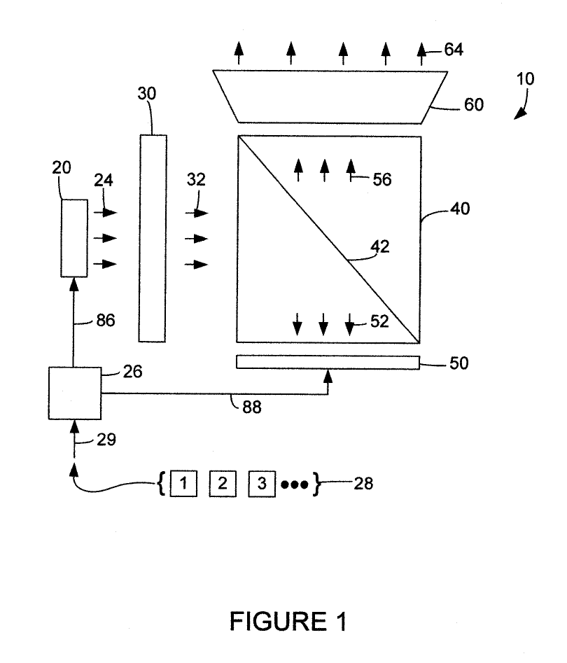

Attention is now directed to the figures wherein like items may refer to like components throughout the various views. FIG. 1 is a diagrammatic representation of a sequential display arrangement, produced according to an embodiment of the present disclosure, and generally indicated by the reference number 10. It is noted that optical elements such as, for example, various lens arrangements can form part of display arrangement 10 as will be recognized by those of ordinary skill in the art, however, these elements have not been shown for purposes of illustrative clarity. A light source 20 which can, for example, comprise LEDs emits non polarized light 24 which is indicated by arrows. The light source is driven by a controller 26 to selectively emit light, which can be white light in one embodiment for producing a monochrome display. In another embodiment, the light source can selectively emit colored light such as, for example, red, green and blue light, as will be further described at an appropriate point hereinafter. In the instance of either, white or color light, one or more lenses can handle light 24 such that the light is of sufficient uniformity for illuminating a given microdisplay having a given shape and a given aspect ratio, as will be further described. Controller 26 generates signals based on an input signal 28 received on an input signal line 29. Input signal 28 can be an incoming video stream that is made up of frames, three of which are shown and labeled as 1, 2 and 3. Light 24 is polarized by a polarizer arrangement 30. In the instance of light source 20 initially emitting polarized light, however, polarizer arrangement 30 may not be needed. In the present embodiment, polarized light 32 can then enter a polarizing beam splitter (PBS) 40. A beam splitting hypotenuse face 42 of the PBS reflects the polarized light onto a display such as, for example, an FLCOS microdisplay 50. With respect to PBS 40, it should be appreciated that other embodiments can use another suitable form of polarization dependent reflective arrangement such as, for example, a reflective polarizer. The reflected polarized light is indicated by the reference number 52 and is represented using arrows. The microdisplay selectively modulates and reflects the incoming light to produce modulated output light 56. In the present embodiment, when a given pixel is in an off state, the polarization of light reflected from the given pixel is rejected by PBS 40 whereas when the given pixel is an on state, the polarization of the reflected light is switched and therefore passes through the PBS as modulated output light 56. The modulated output light can be received by a projection lens arrangement 60 and emitted as projection light 64 which can be incident upon any suitable surface for purposes of viewing. The present disclosure considers the use of a projection light engine for descriptive purposes, however, the teachings herein are not limited to projection light engines but are equally applicable with respect to any form of field sequential display. While the present disclosure remains applicable to any suitably shaped display having any suitable aspect ratio, the disclosure will consider the use of a 16 by 9 display. Each of 9 rows of pixels includes 16 pixel columns, as illustrated, to make up the 16 by 9 display. An actual display will generally include far more pixels such as, for example, an array of 1280×720 pixels for a high definition 16 by 9 display, or an array of 960×540 for a standard definition display.

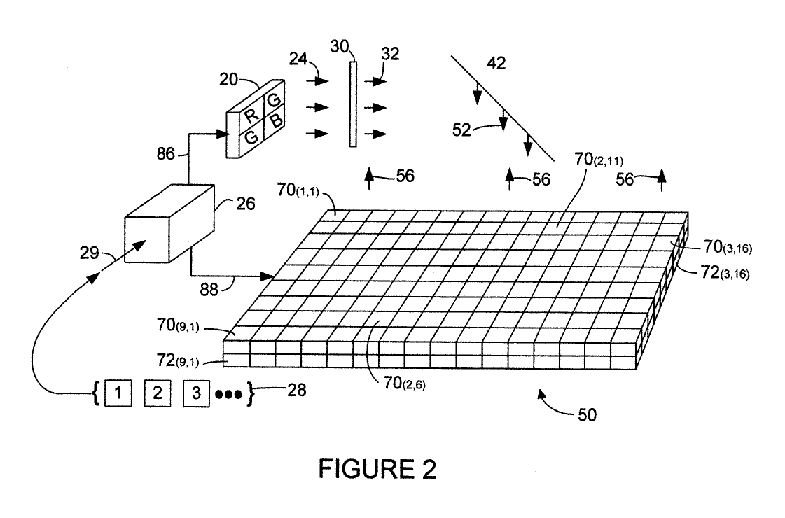

Referring to FIG. 2 in conjunction with FIG. 1, the former diagrammatically illustrates at least the components of display arrangement 10 that are controlled by controller 26. In particular, controller 26 is in electrical communication with light source 20 and microdisplay 50. In the illustrated embodiment, light source 20 includes a red LED (R), a blue LED (B) and a pair of green (G) LEDs for purposes of emitting light, which will be familiar to those of ordinary skill in the art. In FIG. 2, microdisplay 50 is shown in a diagrammatic perspective view to illustrate the array of pixels that is made up of n columns and k rows of pixels, (in this instance 16 columns and 9 rows), several of which are indicated by the reference number 70 and which may be referred to individually herein with reference to position in the array with a designation format of (column#, row#). Each of the pixels in the array has an associated pixel driver (PD) that is used for driving the state of the pixel under the control of controller 26. Selected ones of the pixel drivers are shown in block form and are indicated by the reference number 72 with an associated array position designation using (column#, row#) of the pixel that the pixel driver is connected to drive.

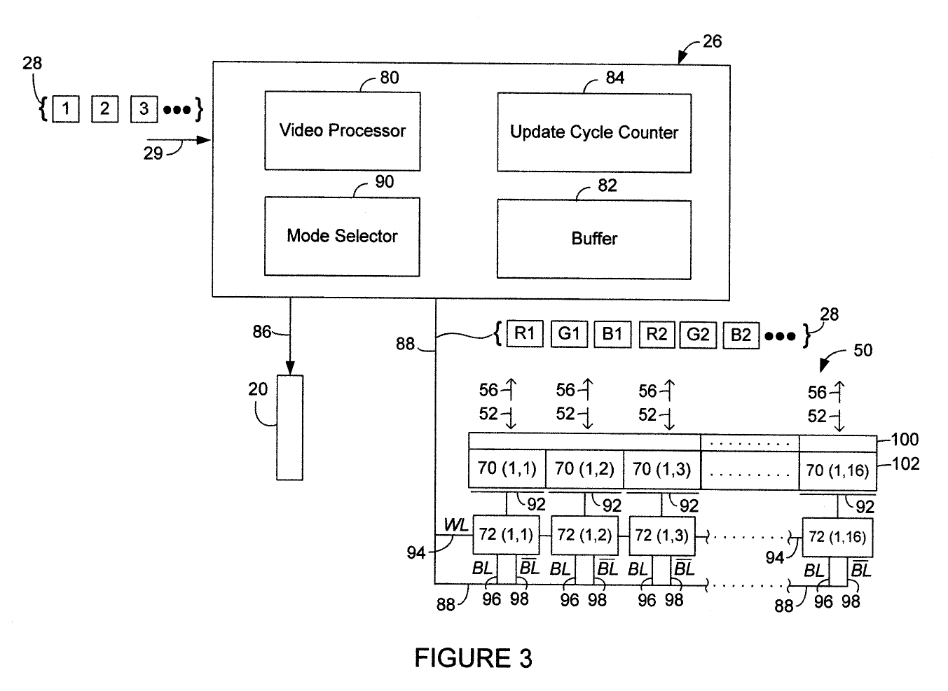

Attention is now directed to FIG. 3 which illustrates an embodiment of controller 26 of FIGS. 1 and 2 shown in block diagram form. Controller 26 includes a video processor 80 that can operate on input video stream 28 in real time to generate individual color subframes associated with each color that light source 20 can emit. Controller 26 can provide control signals over a data line 86 for operating light source 20 to selectively illuminate the display with red, green or blue light. Data associated with subframes can be loaded into a data buffer 82 to provide appropriate timing for loading into display 50 over a data line 88 under control of video processor 80, as will be familiar to one having ordinary skill relating to field sequential color displays. While FIG. 3 illustrates a single buffer for purposes of illustrative clarity, a separate buffer can be provided for each subframe color. Controller 26 can also include an update cycle counter 84 for counting update cycles used in producing grayscale values, as will be discussed in further detail.

FIG. 3 includes a diagrammatic illustration of display 50 in an elevational view. Selected pixel drivers 72_{1,1}, 72_{1,2}, 72_{1,3} and 72_{1,16} are illustrated as electrically connected to pixels 70_{1,1}, 70_{1,2}, 70_{1,3} and 70_{1,16,} respectively, with electrode minors 92. Controller 26 provides control and video data to the pixel drivers of display 50 over data line 88. Rows of pixels can be selected using word line signals on word lines (WL) 94. Bit line set (BL or BLSET) lines 96 and bit line clear ( B̅L̅ or BLCLR) lines 98 are connected to columns of pixels so that any given pixel in a selected row can be set to either the ON state or the OFF state using the bit line set and bit line clear. In the ON state, polarization of the polarized light 52 incident on the pixel can be switched to produce modulated output light 56 which is passed through the PBS (FIGS. 1 and 2); in the OFF state, the polarization of the polarized light 52 incident on the pixel can be unswitched and is rejected by the PBS. The particular configuration of the display with respect to whether polarization switching is performed for the ON state or the OFF state is arbitrary as will be appreciated by one of ordinary skill in the art.

Controller 26 can include a mode selector 90 which can have a selectable lock mode. The mode selector can be used to lock the bit line set and bit line clear lines so that digital “1s” and/or digital “0s” can be blocked from being written to the bit line set and bit line clear lines of the pixel drivers. In one embodiment, by selecting a locked mode of the mode selector, the controller can only write two different sets of values to the BL and B̅L̅ lines. The first set is the BL=1 and B̅L̅=1, which can be referred to as (1,1), maintains the current state of the pixel without refreshing. The second set is the BL=0 and B̅L̅=1, which can be referred to as (0,1), changes the state of the pixel from the ON state to the OFF state. By selecting an unlocked mode of the mode selector, the controller can operate in a conventional manner such that a pixel can be turned OFF or ON for any update cycle. By setting the mode selector to the locked mode, the pixels are suppressed from being refreshed while the pixels are maintained in their current state. For purpose of the present disclosure, pixel refresh involves rewriting an existing state of the pixel. That is, the pixel is rewritten from a given state to the same given state. The use of mode selector 90 will be described in greater detail in the following disclosure.

The display can include a layer 100 of a cover glass and a layer 102 of liquid crystal material is sandwiched between cover glass 100 and electrode mirrors 92. Depending on the voltage state that is applied to each electrode mirror by its associated pixel driver, polarized incoming light 52 can be selectively reflected and modulated by the liquid crystal pixels to produce modulated output light 56. The pixel driver can apply two stable voltage states to the electrode mirror such as, for example, either an ON state voltage at or near an upper voltage or a low voltage in an OFF state. Depending on the voltage on the electrode minor associated with a given pixel, the incoming light incident on the pixel can be modulated by reflecting the incoming light without changing the polarization of the incoming light or by reflecting the incoming light incident on the pixel while causing the liquid crystal layer to rotate the polarization of the incoming light to a crossed polarization, one of which polarizations will pass through beam splitting hypotenuse face 42 of PBS 40 (FIG. 1) as modulated light 56 while the other polarization can be blocked by the hypotenuse face.

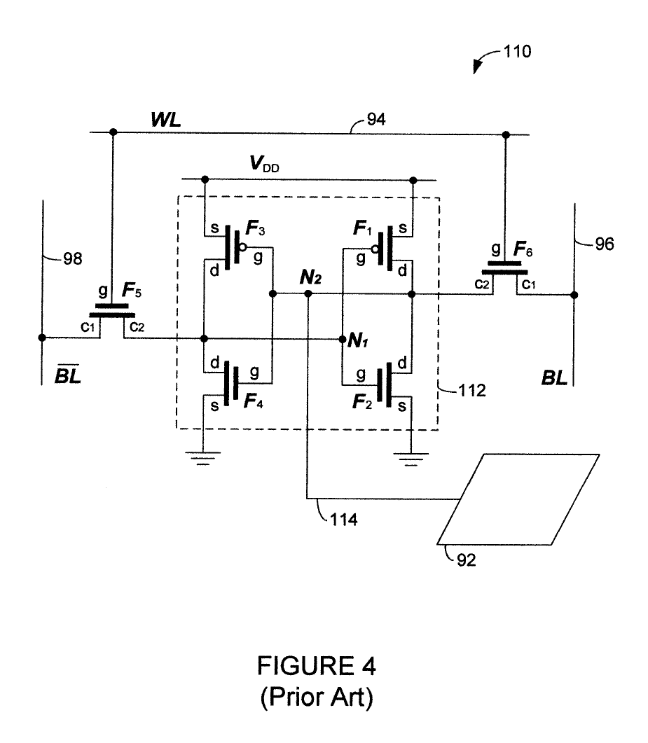

Referring to FIG. 4 in conjunction with FIG. 3, a schematic diagram illustrating an embodiment of a six transistor pixel driver 110 suitable for use as pixel drivers 72 (FIG. 3) is shown. Pixel driver 110 can be an SRAM device which includes an inverter core 112 that is shown within a dashed line, and is made up of a pair of cross-coupled inverters. A first inverter includes a pFET F1 and an nFET F2 having interconnected gates to define a node N1. A second inverter includes a pFET F3 and an nFET F4 having interconnected gates to define a node N2. The source terminals of F2 and F4 are connected to ground while the source terminals of F1 and F3 are connected to a voltage source Vdd which may be referred to as a source voltage. The drain of F1 is electrically connected to the drain of F2 at node N2 while the drain of F3 is electrically connected to the drain of F4 at node N1. Node N2 is electrically connected to electrode minor 92 using electrode minor line 114.

Inverter core 112 and electrode mirror 92 can be controlled through interface control nFETs F5 and F6 using word line (WL) 94, bit line set (BL) line 96 and bit line clear ( B̅L̅) line 98 using digital signals. Application of a source voltage can be considered as a digital “1” and application of zero volts can be considered as a digital “0”. Word line 94 is electrically connected to gates of interface control nFETs F5 and F6. Bit line set (BL) line 96 is connected to a channel terminal C1 of nFET F6 while the other of channel terminal C2 of nFET F6 is electrically connected to node N2. Bit line clear ( B̅L̅) line 98 is connected to one of channel terminal C1 of nFET F5 while channel terminal C2 of nFET F5 is electrically connected to node N2. When control is asserted on word line 94, interface control nFETs F5 and F6 allow bit line set and bit line clear to set the voltages at the nodes N1 and N2 of inverter core 112, having the voltage at node N2 corresponding to the voltage on electrode mirror 92. For descriptive purposes, when node N2 and electrode minor 92 are at zero volts, the associated pixel can be considered as in the OFF state of the associated pixel. Conversely, when node N2 and the electrode minor are at least approximately at the source voltage, the associated pixel can be considered as in the ON state, although it is to be understood that this state assignment is arbitrary depending upon the overall configuration of a given display system.

Applying a digital “1” to word line 94 as a high or upper logic level voltage that can be at least approximately equal to the source voltage, also referred to as asserting the word line, while applying a “1” to bit line set (BL) line 96 forces F4 into conduction and F3 into cutoff; at the same time, applying a “0” to bit line clear ( B̅L̅) as a low logic level voltage that can be at least approximately zero volts on line 98 forces F1 into conduction and F2 into cutoff. Therefore, applying a “1” to bit line set and “0” to bit line reset causes node N2 to be a “1” and N1 to be a “0” thereby setting the pixel to the ON state. Asserting word line WL while applying a “0” to bit line set (BL) line 96 and a “1” to bit line clear ( B̅L̅) line 98 forces F3 into conduction and F4 into cutoff; and forces F1 into cutoff and F2 into conduction to cause node N2 to be a “0” and node N1 to be a “1” thereby setting the pixel to the OFF state. Asserting word line WL while applying a “1” to both bit line set (BL) line 96 and bit line clear ( B̅L̅) line 98 causes the FETs F1, F2, F3 and F4 to remain in whatever state, either conduction or cutoff, in which they previously were set. Setting the bit line set (BL) line and bit line clear ( B̅L̅) line to “11” can be referred to as setting the pixel drivers to a hold or locked state. In the locked state, the interface FETs and the inverter core each try to control the state of nodes N1 and N2, however the pixel driver circuit is designed so that the inverter core always asserts control when matched against the interface FETs in these situations. When word line WL is set to “0”, the states of the nodes N1 and N2 are maintained in isolation from interface lines BL and B̅L̅. Control lines 94, 96 and 98 provide for control of display 50, in coordination with illumination from light source 20, such that each subframe is illuminated by the appropriate color of light and each pixel can be modulated appropriately to provide a desired grayscale value.

In the present example, each subframe set includes a first series of a red, green and blue subframe followed by a second series of a red, green and blue subframe such that each subframe set includes two subframes for each color. It is noted that presentation of the subframes to the viewer in this manner can serve to aid the eye of the viewer in integrating the subframe images for presentation of video at standard rates such as 60 frames per second, although any suitable number and/or sequence of subframes can be used. Of course, a monochrome display may use fewer subframes per frame of incoming video since individual colors are not required. Irrespective of the color makeup of light that is used to illuminate display 50, the display modulates the illuminating light and generates a grayscale image for that illuminating light. For purposes of the present descriptions as well as the appended claims, the terms frame and subframe can refer to any collection of grayscale data that specifies a grayscale value for each pixel of the display that is in use. For example, in the instance of monochrome video, the frame itself can be treated as a subframe and directly displayed on the display in the same manner as an individual color subframe, as described herein, for color video.

It should be appreciated that color sequential displays generally display each subframe using a series of update cycles that is directly based on the number of grayscale values that is available for each pixel. By way of example, in a 7 bit grayscale scheme, there are 128 gray scale values (1-128) available for each pixel. When using this number of grayscale levels, a prior art color sequential display typically performs one update cycle for each grayscale level such that 128 update cycles are performed in order to display a single subframe. In effect, it is as if each subframe is itself divided into 128 subframes. Other grayscale schemes can be used where there are more or less grayscale values, such as 256 or 512 or others.

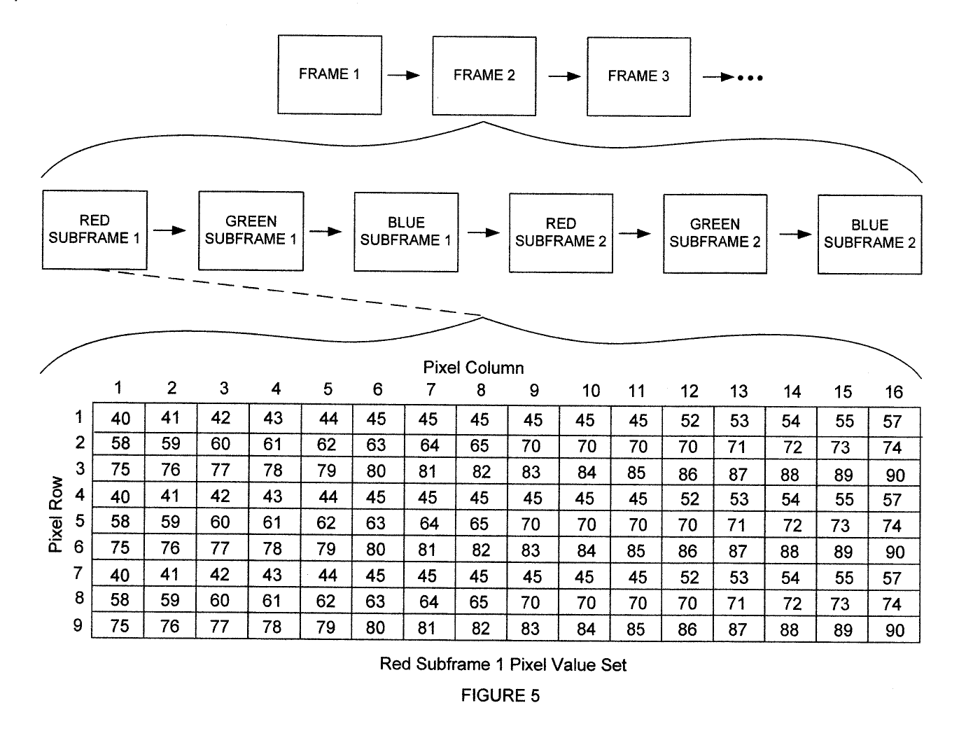

Attention is now directed to FIG. 5 which diagrammatically illustrates three frames labeled as Frame 1-3, taken from video stream 28 (FIGS. 1-3). As is shown for Frame 2, each frame can be used to generate 6 color subframes that are labeled as Red Subframe 1, Green Subframe 1, Blue Subframe 1, Red Subframe 2, Green Subframe 2 and Blue Subframe 2. In the present example, display 50 is shown having a pixel array that is limited to 144 pixels in a 16 by 9 arrangement for purposes of illustrative clarity. Specific grayscale pixel values are given within the area of each pixel, by way of example, for Red Subframe 1. It is noted that these pixel values are not derived from an actual video frame but are hypothetical and have been selected for purposes of illustrating the methods that are being brought to light by the present disclosure. One of ordinary skill in the art, however, will appreciate that there is no difference with respect to the application of these methods to actual video/subframe data. In the present example, 7 bit grayscale pixel values are in use such that the grayscale value for any given pixel can potentially be any value in the range of 1-128. Any suitable number of grayscale pixel values can be used. For purposes of the present disclosure, grayscale values for each pixel can be operationally achieved solely by switching each pixel between an OFF state and an ON state such that light that is reflected in one state is opposite in polarization to the reflected light in the other state. In some embodiments, however, the intensity of light emitted by light source 20 can be modulated in cooperation with pixel switching to achieve grayscale values while remaining within the scope of the teachings herein.

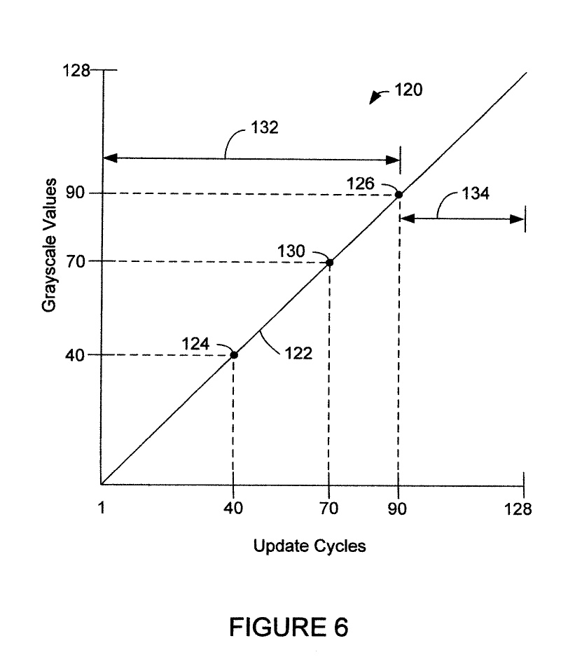

Referring now to FIG. 6 in conjunction with FIG. 5, the former is a plot, generally indicated by the reference number 120, which illustrates potential grayscale values along the vertical axis against update cycles along the horizontal axis for 7 bit grayscale values, shown here to illustrate an update ramp 122. The reader is reminded that the pixels are all initially set to the ON state in the present embodiment, although another embodiment can initialize all the pixels to the OFF state. Therefore, for the present embodiment, a pixel can be seen as having a relatively darker grayscale value when the pixel is switched to the OFF state earlier in the update cycles; and a relatively lighter grayscale value when the pixel is switched to the OFF state later in the update cycles. The data for each subframe specifies a grayscale value for each pixel of display 50. Referring again to FIG. 5, pixel (1,1) at column 1, row 1 having a grayscale pixel value of 40 (shown along update ramp 122 at point 124, FIG. 6), will be seen as darker than pixel (16,9) at column 16, row 9 having a grayscale pixel value of 90 (point 126 on ramp 122, FIG. 6) since pixel 1,1 will be turned OFF much sooner in the update cycles than pixel 16,9 because of the lower grayscale pixel value. In the present embodiment, there are 128 update cycles, starting at 1 and ending at 128. Each pixel is turned OFF when the update cycle count reaches the grayscale pixel value of the pixel. Several pixels may be turned OFF or no pixels may be turned OFF during any particular update cycle depending on the subframe data. For the hypothetical subframe data shown in FIG. 5, no pixels are turned OFF during intermediate update cycles 1-39 and a number of pixels are turned OFF during update cycle 70 at point 130. Intermediate update cycles, as referred to herein, are the update cycles above and/or below the update cycle associated with the grayscale pixel value of a given pixel.

In accordance with the present disclosure and as will be described in detail by way of the hypothetical subframe of FIG. 5, pixel refresh is inhibited from application to certain pixels at certain times. As an example, for a pixel such as pixel (16, 3) in FIG. 5, that has an update cycle at 90 (point 126, FIG. 6), the pixel will remain in the ON state and will not be refreshed during intermediate update cycles 1-89, represented by arrow 132 in FIG. 6 until update cycle 90 is reached. Further, after pixel (16, 3) has been toggled from the ON state to the OFF state by update cycle 90, the pixel is to remain in the OFF state. Further, the OFF state of pixel (16, 3) is not refreshed for the remainder of the intermediate update cycles, represented by arrow 134.

In a conventional color sequential display, each pixel is refreshed for every update cycle. That is, each pixel is repeatedly turned ON in the intermediate update cycles before the update cycle count reaches the assigned grayscale pixel value of the pixel. Thereafter, the pixel is repeatedly turned OFF in the remaining update cycles. Put another way, in a conventional display, word line 94 is asserted and a digital “1” is applied to bit line set (BL) line 96 and a digital “0” is applied to bit line clear ( B̅L̅) line 98 for any given pixel in the array until the update cycle count reaches the assigned grayscale pixel value of the given pixel. Word line 94 is then asserted in conjunction with a digital “0” applied to bit line set (BL) line 96 and a digital “1” applied to bit line clear ( B̅L̅) line 98 for the given pixel for each update cycle in the remainder of the update cycles. Therefore, in the conventional display, the bit line set and bit line clear are updated or refreshed for every pixel in every update cycle, regardless of whether the current state for the given pixel needs to be changed. In certain situations where multiple adjacent pixels in a column alternate between ON and OFF, the bit line set and bit line clear lines for that column may have to be switched back and forth between a “01” and a “10” very rapidly during one or more update cycles in order to refresh the column. Applicants recognize that power is used each time that bit line set or bit line clear is toggled, that is changed from a “0” to a “1” or from a “1” to a “0”. Multiple rapid toggling can cause excessive power use and can cause an increase in heat in the display system. As will be described immediately hereinafter, Applicants have recognized a different approach with respect to performing update cycles which can provide power savings over conventional systems.

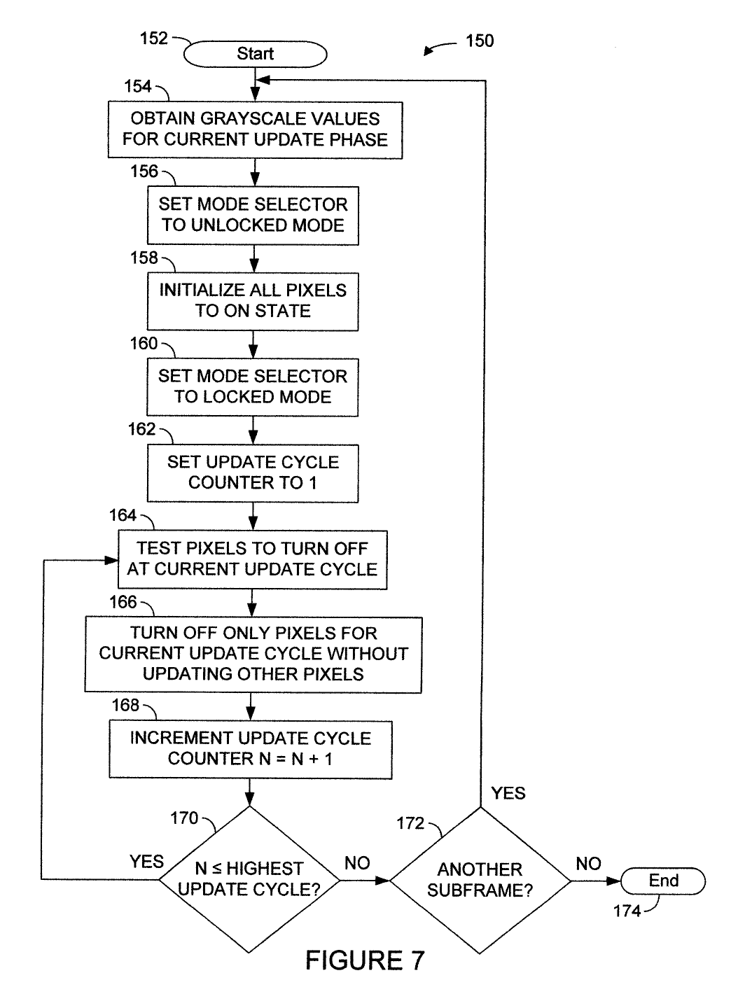

Turning now to FIG. 7, a flow diagram illustrates an embodiment, generally designated by the reference number 150, of a method for performing update cycles in the sequential display arrangement of FIG. 1. Method 150 is illustrated as operating on Red Subframe 1 having the grayscale pixel values provided on display 50 as shown in FIG. 5. The method begins at start 152 and proceeds to 154 where the grayscale values for the current update phase are obtained for the Red Subframe 1 Pixel Value Set (FIG. 5) of input video stream 28 (FIG. 1). Method 150 proceeds to 156 where controller 26 sets mode selector 90 (FIG. 3) to the override or unlocked mode so that the pixels can be written to the ON state. Method 150 then proceeds to 158 and initializes all of the pixels in display 50 to the ON state. Controller 26 can initialize the pixels by asserting the word lines and setting bit line set (BL) line 96 to a “1” and bit line clear ( B̅L̅) line 98 to a “0” for all of the pixels of the display. After the pixels are initialized ON, method 150 proceeds to 160 where controller 26 sets mode selector 90 to the locked mode and sets the bit line set and bit line clear lines to digital “11”. In the present embodiment of the locked mode, the bit line set and bit line clear lines can only be set to the locked state at digital “11”, in which the pixels remain in whatever state that they were set without being refreshed, or can be set to the OFF state at digital “01” to turn a given pixel OFF. The locked state can otherwise be described as maintaining the current state of each pixel that is not being switched to the OFF state for the current update cycle. Method 150 then proceeds to 162 where an update cycle counter 84 is set to N=1. The update cycle counter is used for keeping track of the update cycles by counting to 128 in the present embodiment. Method 150 then proceeds to 164 where the grayscale values for the current update phase obtained at 154 are searched to determine if there are pixels to switch to the OFF state at the current update cycle count. Method 150 then proceeds to step 166 where any pixels determined to have a grayscale value matching the current update cycle count are switched to the OFF state. Only pixels having a grayscale value matching the current update cycle are updated to the OFF state. Pixels that do not have a grayscale value matching the current update cycle are inhibited from being refreshed by maintaining the locked state on the bit lines set and bit line reset lines. Method 150 then proceeds to 168 where the update cycle counter is incremented by setting the counter to N=N+1. Method 150 then proceeds to 170 where a decision is made as to whether N is less than or equal to the highest update cycle, which in the present embodiment is 128. If the decision at 170 is that the update cycle counter is less than or equal to the highest update cycle, then method 150 returns to 164. Method 150 repeats 164 to 170, only updating the pixels from an ON state to an OFF state and then only when the pixels have a grayscale value that matches the current value of the update cycle counter. The method repeats 164 to 170 until the cycle counter exceeds the highest update cycle at which point the determination at 170 is positive and the method proceeds to 172. At 172 a decision is made as to whether there is another subframe. If the decision is positive, method 150 returns to 154 to update the pixels for the next subframe, which in this embodiment is Green Subframe 1 (FIG. 5). If the decision at 172 is that there is not another subframe, method 150 proceeds to 174 where the method ends.

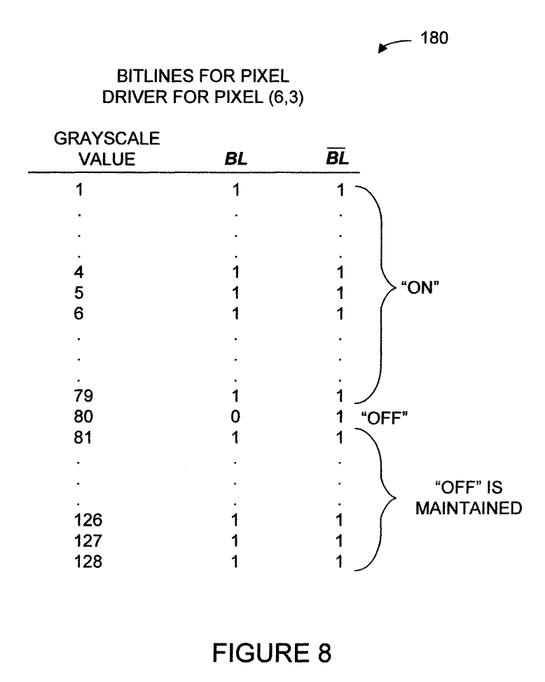

Referring now to FIG. 8 in conjunction with FIG. 7, the former is a table showing an embodiment of an update phase for a single pixel that is generally indicated by the reference number 180. Table 180 illustrates digital values on bit line set (BL) line 96 and bit line clear ( \overline{\overline{BL}}) line 98 (FIG. 3) and grayscale values during the update cycles for a pixel (6,3) in column 6, row 3, of Red Subframe 1 (FIG. 6) and having grayscale value 80. After all of the pixels of display 50 are initialized to an ON state at 156 in FIG. 7, the bit line set (BL) and bit line clear ( B̅L̅) lines can be set to digital 1,1 for pixel (6,3). As the update cycle counter counts upward, the bit line set and bit line clear lines remain at digital 1,1 for pixel (6,3) through intermediate grayscale values until the grayscale value of pixel (6,3) matches the value of the update cycle counter, which in this instance is 80. By maintaining bit line set and bit line clear at digital 1,1 for pixel (6,3), whenever word line WL is asserted for row 3, which includes pixel (6,3), the pixel driver for pixel (6,3) maintains the current state of the pixel, either ON or OFF. When the update cycle counter matches grayscale value 80 of pixel (6,3), the bit line set and bit line clear lines are set to digital 0,1 to toggle the pixel from the ON state to the OFF state to update the pixel. After the pixel is updated, the bit line set and bit line clear lines are set back to digital 1,1 for the remainder of the update phase without refreshing the pixel to maintain the pixel driver in the current OFF state. In the embodiment illustrated for Red Subframe 1, update cycles 81 to 128 are not refreshed. Accordingly, the state of the pixel is changed from ON to OFF at update cycle 80 while no other update cycles are applied.

While the embodiments discussed so far have involved initializing the pixels to an ON state and then using the update cycle counter to count upward, a person of ordinary skill in the art with the present disclosure in hand will recognize that the update cycle counter can be configured to count downward. The update cycle counter can count upward or downward in any embodiment. The choice is arbitrary so long as the result is the desired grayscale value.

In another embodiment, the pixels could be initialized to an OFF state and the update cycle counter could count upward or downward. In this embodiment, the locked mode of the mode selector could be used to suppress refresh cycles of a given pixel until the pixel is updated to an ON state and then again until the update phase of the subframe is complete. This embodiment may be used in a dark phase where the light source is off for purposes of DC balancing the liquid crystal as will be understood to one of ordinary skill in the art.

In another embodiment, the mode selector can be configured with different selectable settings in which pixel refresh can be inhibited in update cycles below the grayscale value, above the grayscale value and/or both below and above the grayscale value in addition to the mode where the controller can refresh and/or set the state of any of the pixels during any update cycle.

In view of the foregoing, each pixel driver can be updated from an ON state to an OFF state once per pixel for an entire update phase without refreshing the state of the pixel. The bit line set and bit line clear lines are otherwise maintained at the digital 1,1 such that toggling of these lines is reduced to provide an associated power reduction. In one empirical example, a conventional system produces a worst case power of consumption with current over 50 mA for a 64 value ramp, while a system implementing based on the method disclosed herein realized a current reduction to below 1 mA for the worst case with a 64 value ramp.

A controller, associated apparatus and method have been described for use in conjunction with a sequential display system including a display having a plurality of pixels. Video can be displayed on the display with the video being made up of a series of frames with each frame having a series of subframes. During operation, the subframes can be updated during a number of update cycles that can be equal to a number of grayscale values that each pixel is capable of displaying. A pixel displaying a darker value of grayscale can have a grayscale value and associated update cycle number that is relatively lower than the grayscale value and associated update cycle number for a pixel displaying a relatively lighter value of grayscale in a given subframe. Pixels having a relatively higher grayscale value can be left in the ON state longer than pixels having a relatively lower grayscale value. After the pixels in the array are set to an initial state, each of the pixels can be toggled to switch states a single time during a subframe. Each pixel remains in the initial state without receiving any sort of rewrite of the initial state until the state of the pixel is changed when the update cycle reaches the pixel's grayscale value, then the pixel remains in the changed state without receiving any rewrite of the changed state until the end of the updates for the subframe. The result can be a reduction in the number of different control signals applied to each of the pixels and a corresponding reduction in power usage by the sequential display system.

The foregoing description of the invention has been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A method for operating a display comprising:
applying initial voltage signals to bit lines of a pixel driver of a pixel of the display to write the pixel to an initial state;
exposing the pixel to light from a light source for a predetermined time period;
dividing the predetermined time period into time increments such that the state of the pixel is writable corresponding to any one of the time increments; and
applying different voltage signals to the bit lines of the pixel driver to write the pixel to a different state at a selected one of the time increments without writing the pixel to either state at any other time increment.

2. A method of claim 1 further comprising selecting the initial state as an ON state.

3. A method of claim 1, further comprising selecting the initial state as an OFF state.

4. A method of claim 1, wherein the light from the light source is one of red, green or blue.

5. A method of claim 1, wherein the time period corresponds to an update phase of the display.

6. A method of claim 1, wherein the time increments correspond to update cycles of the display.

7. A method of claim 1, wherein the time increments correspond to grayscale values of the display.

8. A method of claim 1, wherein the aforementioned pixel is a first pixel and further comprising:
applying initial voltage signals to bit lines of a pixel driver of a second different pixel of the display to write the second pixel to the initial state,
exposing the second pixel to light from the light source for the predetermined time period, and
applying different voltage signals to the bit lines of the pixel driver of the second pixel to write the second pixel to a different state at a different time increment than the first pixel without writing the second pixel to either state at any other time increment.

9. A method of claim 1, wherein the display includes a plurality of pixels and further comprising applying the initial voltage signals to the bit lines of the pixel drivers of all of the pixels in the display and exposing all of the pixels in the display to the light from the light source for the predetermined time period.

10. A method of claim 9, further comprising applying the different voltage signals to the bit lines of the pixel drivers of more than one of the plurality of pixels at more than one time increments to write the pixels to the different state without writing the pixels to either state at any other time increments.

11. A method for operating a display comprising:
writing a pixel of the display to a first state;
exposing the pixel to light from a light source for a time period having a set number of time increments;
maintaining the pixel in the first state for a first portion of the time increments of the time period such that a duration of the first portion of time periods proportionally changes a display characteristic of the pixel; and
writing the pixel to a second, different state at a predetermined time increment after the first portion of the time increments, wherein the pixel is written to each of the first state and second states only once during the time period.

12. A method for operating a display comprising:
applying first voltage signals to bit lines of a pixel driver of a pixel of the display to set the pixel to a first state;
exposing the pixel to light from a light source for a predetermined time period, where the predetermined time period is divided into time increments;
applying second voltage signals to the bit lines of the pixel driver to maintain the pixel in the first state without refreshing the first state for a first portion of the predetermined time period;
applying third voltage signals to the bit lines of the pixel driver to transition the pixel from the first state to a second, different state at a selected one of the time increments associated with the pixel and after the first portion of the time period; and
reapplying the second voltage signals to the bit lines of the pixel driver to maintain the pixel in the second state without refreshing the second state for a remainder of the time period after the time increment associated with the pixel.

13. A method for operating a display comprising:
initiating an unlocked mode of a pixel driver controller in which bit control lines of a pixel driver for a pixel of the display are operable to set the pixel to a first state; and
initiating a locked mode of the pixel driver controller in which the bit control lines of the pixel driver for the pixel are only operable to maintain a current state of the pixel and to transition the pixel from the first state to a second, different state.

14. A pixel driver controller for operating a display comprising:
an unlocked mode in which bit control lines of a pixel driver for a pixel of the display are operable to set the pixel to a first state; and
a locked mode in which the bit control lines of the pixel driver for the pixel are only operable to maintain a current state of the pixel and to transition the pixel from the first state to a second, different state.

15. A method for operating a display comprising:
writing a pixel of the display to an initial state;
exposing the pixel to a light source for a predetermined time period; and
writing the pixel to a different state at a selected time within the predetermined time period after an initial portion of the predetermined time period, wherein voltage levels of a set of control lines of the pixel driver circuit are set to write the pixel to the different state only once during the predetermined time period.

16. An apparatus for operating a display comprising:
a controller configured to apply initial voltage signals to bit lines of a pixel driver of a pixel of the display to write the pixel to an initial state;
a light source to produce light to illuminate the pixel and wherein the controller is further configured to control the light source to expose the pixel to the light for a predetermined time period; and
a counter configured to divide the predetermined time period into time increments such that the state of the pixel is writable corresponding to any one of the time increments, and wherein the controller is further configured to apply different voltage signals to the bit lines of the pixel driver to write the pixel to a different state at a selected one of the time increments without writing the pixel to either state at any other time increment.

17. The apparatus of claim 16, wherein the controller is further configured to write the initial state as an ON state.

18. The apparatus of claim 16, wherein the controller is further configured to write the initial state as an OFF state.

19. The apparatus of claim 16, wherein the light source produces one of red, green or blue light.

20. The apparatus of claim 16, wherein the time period corresponds to an update phase of the display.

21. The apparatus of claim 16, wherein the time increments correspond to update cycles of the display.

22. The apparatus of claim 16, wherein the time increments correspond to grayscale values of the display.

23. The apparatus of claim 16, wherein the display includes a plurality of pixels and the controller is further configured to apply the initial voltage signals to the bit lines of the pixel drivers of all of the pixels in the display and the light source is configured to illuminate all of the pixels and the controller is configured to control the light source to expose all of the pixels in the display to the light from the light source for the predetermined time period.

24. The apparatus of claim 23, wherein the controller is configured to apply the different voltage signals to the bit lines of the pixel drivers of more than one of the plurality of pixels at more than one time increment to write the pixels to the different state without writing the pixels to either state at any other time increments.
